(19) United States
(12) Patent Application Publication
(10) Pub. No.: US 2021/0089993 A1
(43) Pub. Date: Mar. 25, 2021

(54) ASSESSMENT DEPLOYMENT AUTO-PILOT

(71) Applicant: Microsoft Technology Licensing, LLC, Redmond, WA (US)

(72) Inventors: Christian V. Mathiesen, San Jose, CA (US); Emrecan Dogan, Menlo Park, CA (US); Mustafa Emre Kazdagli, Palo Alto, CA (US); Alp Artar, San Francisco, CA (US)

(21) Appl. No.: 16/577,241

(22) Filed: Sep. 20, 2019

(51) Int. Cl. G06Q 10/06; G06Q 10/10

(52) U.S. Cl. CPC G06Q 10/063112; G06N 20/00; G06Q 10/1053; G06Q 10/06398

(57) ABSTRACT

Techniques for automatically deploying assessments over a computer network are provided. In one technique, an assessment is stored for applicants of an opportunity. First input that indicates that a first user applied for the opportunity is received. In response to receiving the first input, it is automatically determined to transmit a first assessment invitation to the first user. Second input that indicates that a second user applied for the opportunity is received. In response to receiving the second input, it is automatically determined to not transmit a second assessment invitation to the second user. Factors that may be considered in determining whether to transmit an assessment invitation include attributes (such as a review history) of the entity that created the opportunity or posting thereof, attributes (such as an assessment taking history) of the user that applied for the opportunity, and a current workload of the entity and of the user.

### TECHNICAL FIELD

The present disclosure relates to deploying assessments over a computer network and, more particularly to, automatically selecting which applicants will receive an assessment based on reviewer attributes and/or applicant attributes.

### BACKGROUND

The Internet has facilitated the rapid development of modern technologies, including instant communication and coordination regardless of geography. Modern technology has transformed many industries, including talent acquisition. Hirers have access to a virtually limitless pool of geographically dispersed candidates while candidates can be matched to organizations with very little effort. A drawback to the fact that the Internet and other technologies has made applying to opportunities frictionless is that a hirer must now sift through many applications for the proper applicants to pursue, such as with call-back interviews or in-person interviews. Such sifting is a manual-intensive process.

One way to address this problem is through online assessments. An online assessment may ask an applicant to answer a set of questions (whether multiple choice or freeform), watch a video and then answer questions, and/or write a program (in a particular software coding language) to perform a particular set of functions. Online assessments are highly impactful in identifying a potential match between an applicant and a certain opportunity. If an applicant passes an assessment, then the applicant is more likely to be qualified for an opportunity than other applicants who have not passed the assessment. However, assessments have a drawback of their own. Depending on the type of assessment, it might take a significant amount of time for an applicant to complete. Given this significant time investment, many applicants are cautious about engaging in “unnecessary” assessment experiences. Applicants are willing to take an assessment when they know that their assessment results will change the outcome of the hiring process, or at least, when they know that they will hear back from the hirer.

However, too often, hirers do not respond quickly or at all after an applicant completes an assessment. For example, 100 seekers apply for a given opportunity. A hirer for that opportunity wants to ensure that the applicants have all the important data to consider for candidacy. For this reason, in one approach, the hirer sets a blanket rule to require all applicants to take one or more assessments. This creates a waste of effort on the part of many applicants as the hirer is unlikely to review all the applicants to an opportunity.

The blanket rule creates an adverse selection problem in the candidate pool of an opportunity. Applicants that are relatively more qualified tend to decline assessment requests more often, as they have better opportunities in the talent acquisition space. This subset of applicants tends to have a higher bar for accepting assessment requests. In the adverse selection case, a hirer might be deterring the candidates that the hirer wants to consider the most by requiring assessments as default from all applicants.

In another approach that does not involve a blanket rule, hirers are required to manually select which applicants will receive an assessment. However, such a manual process takes a significant amount of time since they would have to manually review each application before determining whether to send an assessment request to the corresponding applicant. Even with a manual approach to assessment determination, hirers have little (if any) incentive to be selective in which applicants will receive an assessment. As a result, hirers will likely manually select all applicants to their respective opportunities without reviewing any of the corresponding applications, thus resulting in the waste of effort on the part of many applicants and causing seeker dissatisfaction in the long term.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for automatically deploying assessments to applicants, in an embodiment;

FIG. 2 is a flow diagram that depicts an example process for determining whether to send an assessment invitation to an applicant, in an embodiment;

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for automatically selecting which applicants will receive an assessment request are provided. In one technique, one or more attributes of a hirer are taken into account when automatically determining whether to invite an applicant to take one or more assessments. Example attributes include a review history of the hirer and a current number of applicants that have already taken the assessment. In a related technique, one or more attributes of an applicant are taken into account when automatically determining whether to invite the applicant to take one or more assessment. Example attributes include an opportunity match score, an assessment acceptance rate, an assessment completion rate, and a current workload of the applicant. In both techniques, some applicants will receive an assessment request and others will not. Additionally, some applicants may receive an assessment request, but only after the lapse of a certain amount of time.

Embodiments improve computer technology related to online assessments of applicants to job opportunities. Instead of a blanket rule of requiring all applicants to take an online assessment, assessment invitations are automatically and intelligently sent to select applicants and, optionally, delayed to some applicants. Such technology reduces the burden on hirers in deciding which applicants to send assessment invitations. Also, such technology prevents the potential wasted effort on behalf of numerous applicants.

Without this technology, under a blanket rule requiring all applicants to take an assessment, seeker retention and liquidity in an opportunity platform would be negatively affected. This problem is referred to as the “application black hole” where seekers would begin to choose a different opportunity platform to apply for opportunities. Seekers tend to select opportunity platforms based on a number of important Net Promoter Score (NPS) drivers. One of the four most important NPS drivers is the probability (or “odds”) of hearing back. This perception of the job seeker defines whether the job seeker thinks there is activity and momentum in a certain talent acquisition space, and this has the largest weight on whether the job seeker is retained.

To be perceived as the most active talent acquisition space, the number of opportunities available is not sufficient. An opportunity platform needs to demonstrate to job seekers that the odds of hearing back is the highest among similar opportunity platforms. In other words, when seekers take actions (e.g., applying to an opportunity, completing an assessment, engaging in an interview), not only do they want to hear back from the hirer, they want to hear back from the hirer in a short amount of time. Hearing back does not need to be always positive, but a response should be provided for every reciprocal action a seeker takes. If seekers apply to an opportunity, then they should know if they are rejected. If seekers take a video assessment, then they should hear back on when the video is reviewed by the hirer. Overall, seekers build the perception of an opportunity platform being “alive” and “dynamic” based on the reciprocating actions they receive back from hirers. When reciprocating actions are low in density, job seekers, especially higher quality job seekers, tend to leave the opportunity platform. Embodiments address this problem by not indiscriminately sending assessment invitations to all applicants of a job opportunity, but rather using a data driven approach to determining if, and potentially when, an assessment invitation will be sent to an individual applicant.

### Definitions

A job poster is an individual, an organization, or a group of individuals responsible for posting information about a job opportunity. A job poster may be different than the entity that provides the job (i.e., the “job provider”). For example, the job poster may be an individual that is employed by the job provider. As another example, the job poster may be a recruiter that is hired by the job provider to create one or more job posting. A job provider may be an individual, an organization (e.g., company or association), or a group of individuals that require, or at least desire, a job to be performed.

A “job” is a task or piece of work. A job may be voluntary in the sense that the job performer (the person who agreed to perform the job) has no expectation of receiving anything in exchange, such as compensation, a reward, or anything else of value to the job performer or another. Alternatively, something may be given to the job performer in exchange for the job performer's performance of the job, such as money, a positive review, an endorsement, goods, a service, or anything else of value to the job performer. In some arrangements, in addition to or instead of the job provider, a third-party provides something of value to the job performer, such as academic credit to an academic institution.

A “job opportunity” is associated with a job provider. If a candidate for a job opportunity is hired, then the particular entity becomes the employer of the candidate. A job opportunity may pertain to full-time employment (e.g., hourly or salaried), part-time employment (e.g., 20 hours per week), contract work, or a specific set of one or more tasks to complete, after which employment may automatically cease with no promise of additional tasks to perform.

A “job seeker” is a person searching for one or more jobs, whether full-time, part-time, or some other type of arrangement, such as temporary contract work. A job seeker becomes an applicant for a job opportunity when the job seeker applies to the job opportunity. Applying to a job opportunity may occur in one of multiple ways, such as submitting a resume online (e.g., selecting an “Apply” button on a company page that lists a job opportunity, selecting an “Apply” button in an online advertisement displayed on a web page presented to the job seeker, or sending a resume to a particular email address) or via the mail, or confirming with a recruiter that the job seeker wants to apply for the opportunity.

A “job application” is a set of data about a job applicant submitted for a job opportunity. A job application may include a resume of the applicant, contact information of the applicant, a picture of the applicant, an essay provided by the applicant, answers to any screening questions, an indication of whether any one of one or more assessment invitations have been sent to the applicant, an indication of whether the applicant completed any of the one or more assessments, and results of any assessments that the applicant completed. A resume or other parts of a job application may list skills, endorsements, and/or qualifications that are associated with the applicant and that may be relevant to the job opportunity.

A “reviewer” is an individual, an organization, or a group of individuals responsible for reviewing applications for one or more job opportunities. A reviewer may be the same entity as the job poster. For example, a reviewer and the corresponding job poster may refer to the same company. Alternatively, a reviewer and the corresponding job poster may be different individuals associated with (or otherwise affiliated with) the same company. In that situation, one person is responsible for posting a job and another person is responsible for reviewing applications. Alternatively, a reviewer may be affiliated with a different party than the job poster. In fact, the job provider, the job poster, and the reviewer may be different parties/companies.

An online “assessment” is test that an applicant performs or “takes” and is associated with a job opportunity. An assessment may be required or optional for consideration for the job opportunity. A job opportunity may be associated with (e.g., require or request) zero, one, or more assessments. An example assessment includes a set of questions, such as multiple choice questions, freeform questions, and questions that ask the applicant to match one set of items with another set of items. The set of questions may come before or after a video, audio, or other media presentation. Other example assessments include playing an online game, writing software code (within a certain period of time) to accomplish a specific task, and performing physical movements that the assessment instructs the applicant to perform and that are captured by an image capturing device (e.g., a video camera). A job seeker/applicant may take and complete an assessment in a single session (i.e., a continuous, but limited period of time) or in multiple sessions. An assessment may be taken in a certain location or from anywhere an applicant has a network connection. Thus, an online assessment may be delivered to, and displayed on, an applicant's personal computing device.

An “assessment invitation” (or “assessment request”) is an invitation to an applicant to take an assessment. The invitation may include a name of the assessment, instructions on how to access the assessment (e.g., including a URL for the assessment), an indication of the length in time to complete the assessment, an indication of when to complete the assessment by (e.g., a completion date), and indication of what tools (if any) are needed to take the assessment, an indication of whether the applicant will be notified that his application and/or assessment has been reviewed by a reviewer, and/or an indication of how long it might take for the applicant to hear back from a reviewer. Additionally, the invitation may include the assessment itself, such as a set of multiple-choice questions.

### System Overview

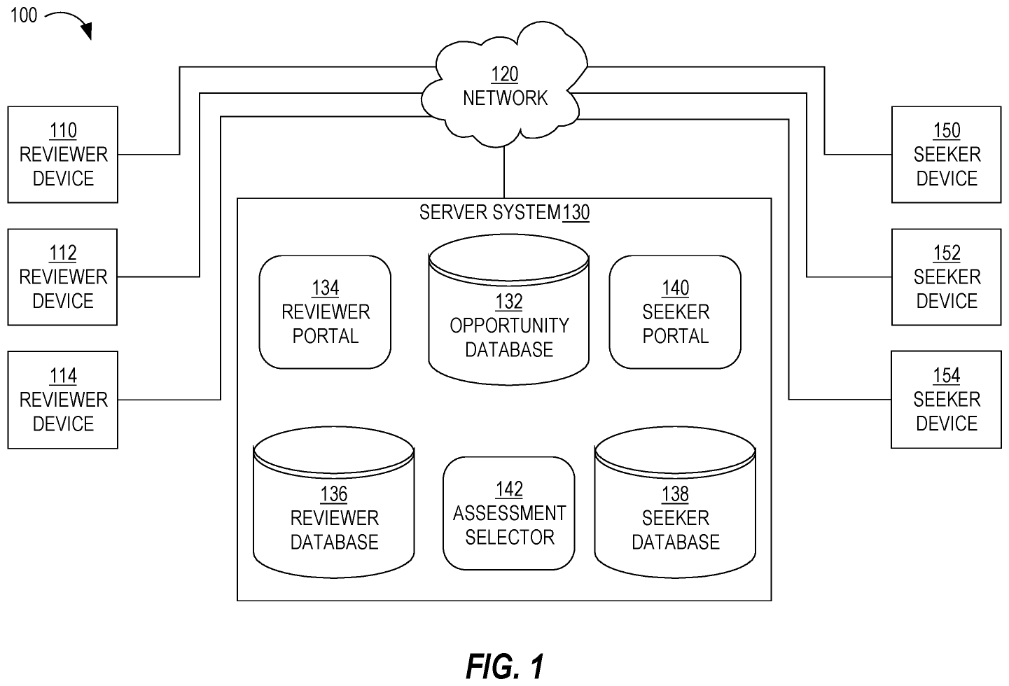

FIG. 1 is a block diagram that depicts an example system 100 for automatically deploying assessments to applicants, in an embodiment. System 100 includes reviewer devices 110-114, a network 120, a server system 130, and seeker devices 150-154. Reviewer devices 110-114 are operated by end-users and send data and/or requests to server system 130 over network 120 (such as a local area network (LAN), wide area network (WAN), or the Internet). Similarly, seeker devices 150-154 are operated by end-users and send data and/or requests to server system 130 over network 120 or another computer network. Examples of devices 110-114 and 150-154 include desktop computers, laptop computers, tablet computers, wearable devices, video game consoles, and smartphones. Also, although only a single network 120 is depicted and described, devices 110-114 and 150-154 may be communicatively connected to server system 130 through different computer networks.

Server system 130 comprises an opportunity database 132, reviewer portal 134, a reviewer database 136, a seeker database 138, a seeker portal 140, and an assessment selector 142. Reviewer portal 134, seeker portal 140, and assessment selector 142 may be implemented in software, hardware, or any combination of software and hardware.

Databases 132, 136, and 138 may be stored on one or more storage devices (persistent and/or volatile) that may reside within the same local network as server system 130 and/or in a network that is remote relative to server system. Thus, although depicted as being included in server system 130, each storage device may be either (a) part of server system 130 or (b) accessed by server system 130 over a LAN, a WAN, or the Internet. Also, each of databases 132, 136, and 138 may be any type of database, such as a relational database, an object database, an object-relational database, a NoSQL database, or a hierarchical database.

Each element of system 100 is described in more detail herein.

### Process Overview

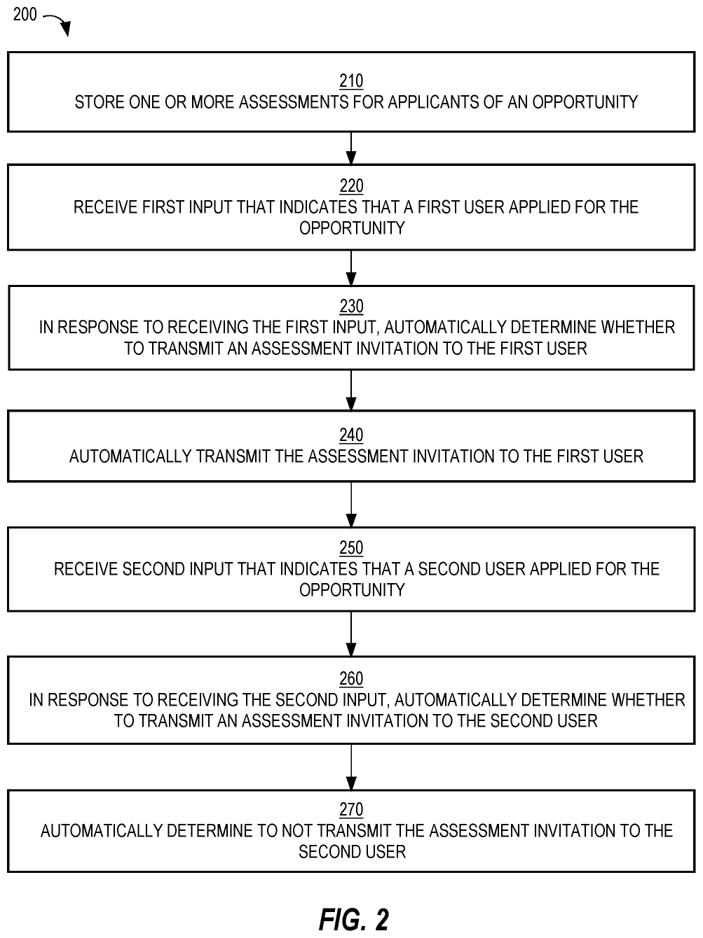

FIG. 2 is a flow diagram that depicts an example process 200 for determining whether to send an assessment invitation to an applicant, in an embodiment. Process 200 may be performed by different components or elements of server system 130.

At block 210, one or more assessments for applicants of an opportunity are stored. Block 210 may involve receiving assessments from reviewer devices 110-114 (or another source) and storing the assessments in opportunity database 132.

At block 220, first input that indicates that a first user applied for the opportunity is received. For example, assessment selector 142 receives input from seeker portal 140 that an applicant (e.g., operating seeker device 150) applied for a particular opportunity indicated in opportunity database 132.

At block 230, in response to receiving the first input, it is automatically determined whether to transmit an assessment invitation to the first user. For example, assessment selector 142 considers one or more attributes of the first user and/or one or more attributes of a reviewer associated with the opportunity. Such attributes are described in more detail herein.

At block 240, it is automatically determined to transmit the assessment invitation to the first user. Transmitting the assessment invitation may involve generating and sending an email to an email account of the first user, sending an SMS message to a computing device of the first user, or sending a notification to an online account of the first user, which may trigger a notification that is pushed to the computing device, of the first user, that has a particular software application installed and active thereon.

At block 250, second input that indicates that a second user applied for the opportunity is received. Block 250 is similar to block 220, except that the second user is different than the first user. However, the second input may be originated through a different channel than the first input. For example, the first user may have applied via a website hosted by the job provider of the opportunity, which is integrated with server system 130 while the second user may have applied via a web page that is dedicated to the job provider (e.g., a company page) but that is hosted by an entity that hosts server system 130. Thus, other job providers may have their own dedicated web pages that are hosted by the same entity.

At block 260, in response to receiving the second input, it is automatically determined whether to transmit an assessment invitation to the second user. Block 260 is similar to block 220. For example, assessment selector 142 considers one or more attributes of the second user and/or one or more attributes of the reviewer associated with the opportunity. While the types of attributes that are considered may be the same as those considered in block 220, the attribute values may be different. For example, value(s) for the one or more attributes of the second user may be different than the value(s) for the one or more attributes of the first user. As another example, value(s) for the one or more attributes of the reviewer may be different when the first user is considered (e.g., at time T1) than the value(s) for the one or more attributes of the reviewer when the second user (at time T2). For example, the reviewer may have a different workload at T2 relative to T1 or may be reviewing more applicants per review session than before.

At block 270, it is automatically determined to not transmit the assessment invitation to the second user. Block 270 may be a final determination, in which case an assessment invitation will never be transmitted to the second user. For example, the second user might not meet the basis qualifications required by the opportunity (and, for example, outlined in the corresponding job posting). Alternatively, block 270 may be a temporary determination, in which case an assessment invitation is delayed temporarily (e.g., due to the relatively infrequent review sessions conducted by the reviewer) or a final determination of whether to transmit the assessment invitation is delayed (e.g., due to a low likelihood that the applicant will take the assessment or due to a low relevance of the applicant to the opportunity). The factors that assessment selector 142 considers in determining whether to transmit an assessment invitation to an applicant are described in more detail herein.

### Opportunity Database

Opportunity database 132 comprises data about each of one or more job opportunities. Data about a job opportunity is stored in a record or entry. Data about a job opportunity includes information in the corresponding job posting, such as name of the job provider or employer, a job title, an industry, a description of the opportunity, and skills required for the job. Data about a job opportunity may also include a set of screening questions and one or more assessments for the job opportunity.

A record for a job opportunity may also include (e.g., a link to) data regarding how the corresponding job posting is performing, such as a number of impressions of the job posting (which may be a proxy for the number of seekers who have viewed the job posting), a number of seekers who have selected the job posting, a number of seekers who have applied to the job opportunity, a number of seekers/applicants who have received invitations to take an assessment, a number of seekers/applicants who have accepted invitations to take an assessment, a number of seekers/applicants who have begun an assessment, a number of seekers/applicants who have completed an assessment, and, on a per-applicant basis, an indication of which of these actions (e.g., invited, began, completed) have been performed relative to the assessment.

In an embodiment, a record for a job opportunity indicates a number of applicants that are already rated as a good fit, a maybe, or not a fit. Such a rating may be based on how well the corresponding job posting attributes match the applicant's attributes and whether the applicant has successfully completed an assessment for the job opportunity. For example, the following factors may increase a rating of an applicant, if the job title of the job posting matches the job title of the applicant, a high percentage of the skills listed in the job posting match (or nearly match) skills associated with (e.g., listed in a profile of) the applicant, and a relatively high score (e.g., in the 90^{th} percentile) on an assessment.

In an embodiment, a record for a job opportunity indicates various stages in which applicants are in the hiring pipeline, such as invited to a telephone interview, scheduled a telephone interview, completed a telephone interview, invited to an onsite interview, scheduled an onsite interview, and completed an onsite interview. For example, the number of applicants that have been invited to each type of interview may be generated and stored in the record, etc. Those applicants that have scheduled or completed an onsite interview may be considered close to hiring.

With this type of information (e.g., number of applicants rated as good fit and number of applicants close to hiring), it is possible to measure how close a job opportunity will be filled by an applicant. Given the density of viable applicants in the hiring pipeline, it can be determined (e.g., by assessment selector 142) which remaining applicants are still viable to become a serious candidate for the job opportunity. These parameters may deeply influence whether a reviewer will keep reviewing new, fresh candidates and how high the bar is for remaining candidates to become viable for the reviewer, given the current pipeline. For example, if the job opportunity is only to be filled by one applicant and ten applicants have scheduled an interview, then the reviewer is unlikely to review any more applicants (or their corresponding assessment results). On the other hand, if a job opportunity is for three applicants and only two applicants have successfully completed an assessment, then the reviewer is more likely to review additional applicants. Reviewers may start out very actively in reviewing applicants, but their review behavior patterns may shift significantly as they qualify more applicants into the more advanced stages of the hiring funnel/process (e.g., on-site interviews). Thus, based on a job opportunity's progress, the extent to which assessment selector 142 triggers the sending of assessments may be adjusted.

### Reviewer Device

Reviewer devices 110-114 interact with server system 130 over network 120 through reviewer portal 134. For example, reviewer portal 134 receives login credentials from a reviewer device, identifies an account associated with the login credentials, and presents data based on the identified account. A reviewer device submits requests to server system 130 via reviewer portal 134. Requests may be generated and submitted in response to user input to a user interface displayed on the reviewer device, such as selection of a graphical button. The reviewer device executes a client application, which may be a native application or a web application that executes within a web browser, such as Internet Explorer, Mozilla Firefox, and Google Chrome.

The client application displays the user interface and includes selectable options for navigating and presenting the corresponding opportunity information, such as one or more job postings associated with the account, and, for each job posting, one or more available assessments for that job posting, a total number of applicants (of the job posting) that have received an assessment, which applicants have received an assessment, which applicants have started but not completed an assessment, which applicants have completed an assessment, results of an assessment from a particular applicant, which applicants have received an invitation to interview, which applicants have accepted or declined to an interview invitation, which applicants have had an interview, whether a final decision has been made for each applicant and, if so, what that decision is.

### Reviewer Database

Reviewer database 136 comprises data about operators (referred to as “reviewers”) of reviewer devices 110-114. Such data might not be visible to the operators/reviewers. Instead, such data is used by assessment selector 142. Reviewer portal 134 records activities performed by a reviewer, such as a number of page views of individual applicants, when each such page view occurred, and decisions that the reviewer made for each applicant, such as interview, decline, or wait. Reviewer portal 134 may also record, in reviewer database 136, how frequently a reviewer reviews applicants and, when a review session is conducted by a reviewer, a number of applicants that the reviewer reviews. Reviewer portal 134 (or another component, such as assessment selector 142) may also calculate a frequency or rate of reviewing applicants per unit of time (e.g., number of applicants reviewed per ten minutes) and a rate of change in pace of reviewing, such as 10 applicants reviewed per hour on day 1 and 15 applicants reviewed per hour on day 8. Such an increase change in rate may indicate that the reviewer may be able to handle reviewing more applicants who have completed assessments. A decrease change in rate of reviewing may indicate that the reviewer is satisfied with the applicants that the reviewer has seen thus far and does not envision reviewing many additional applicants. Alternatively, a decrease change in rate may indicate that the reviewer is dissatisfied with the review process and is, therefore, unlikely to review many more applicants.

Such a class of data helps determine an optimal number of candidates that should have assessment results available for the reviewer's next expected review session.

### Seeker Device

Seeker devices 150-154 interact with server system 130 over network 120 through seeker portal 140. Seeker devices 150-154 may be similar to reviewer devices 110-114. For example, seeker portal 140 receives login credentials from a seeker device, identifies an account associated with the login credentials, and presents data based on the identified account. A seeker device submits requests to server system 130 via seeker portal 140. Requests may be generated and submitted in response to user input to a user interface displayed on the seeker device, such as selection of a graphical button. The seeker device executes a client application, which may be a native application or a web application that executes within a web browser, such as Internet Explorer, Mozilla Firefox, and Google Chrome.

The client application displays the user interface and includes selectable options for navigating and presenting the corresponding opportunity information, such as one or more job opportunities that the seeker viewed, one or more job opportunities to which the seeker applied and, for each such applied opportunity, an indication of whether the seeker received an assessment invitation, whether the seeker accepted the assessment invitation, whether the seeker started the assessment (if accepted), whether the seeker completed the assessment (if begun), a score/results of the assessment (if available), whether the reviewer has acknowledged or reviewed results of the assessment, and whether the seeker has been invited to interview (such as a phone interview or an onsite interview) and/or some other post-assessment invitation.

### Seeker Database

Seeker database 138 comprises data about operators (referred to as “seekers”) of seeker devices 150-154. Such data might not be visible to the operators/seeker. Instead, such data is used by assessment selector 142. Seeker portal 140 records activities performed by a seeker, such as a number of page views of individual opportunities, when each such page view occurred, whether the seeker applied to a presented opportunity, whether the seeker was presented with an assessment invitation, whether the seeker accepted an assessment invitation, whether the seeker started an assessment, whether the seeker completed an assessment, a score or result of a completed assessment, and whether the seeker has followed up with a job provider or reviewer of a completed assessment.

Seeker portal 140 may also record, in seeker database 138, how frequently a seeker applies to opportunities, how frequently the seeker reviews the status of opportunities for which the seeker has applied, how frequently the seeker is reviewing new opportunities (or opportunities for which the seeker has not yet applied), and, when such review sessions are conducted by a seeker, a number of opportunities that the seeker reviews. Seeker portal 140 (or another component, such as assessment selector 142) may also calculate a frequency or rate of applying to and/or reviewing opportunities per unit of time (e.g., number of opportunities applied to per ten minutes) and a rate of change in pace of applying or reviewing, such as 10 opportunities applied to per hour on day 1 and 15 opportunities applied to per hour on day 8.

### Assessment Selector

Assessment selector 142 determines whether to send an assessment invitation (or “assessment request”) to a seeker that has applied to an opportunity. Assessment selector 142 takes into account one or more factors in making the determination. Such factors may be related to one or more attributes of a reviewer associated with the opportunity and/or one or more attributes of the seeker/applicant. Such factors are described in more detail herein.

### Match Between an Opportunity and an Applicant

In an embodiment, one factor that assessment selector 142 considers in determining whether to send an assessment invitation to an applicant for an opportunity is a level of match between one or more attributes of the opportunity and one or more attributes of the applicant. Assessment selector 142 may implement a model or rely on a model that takes features of the opportunity and the applicant as input and generates a match score that indicates a relevance between the opportunity and the applicant. The match score may be input in determining whether and, optionally, when to send an assessment invitation to the applicant. The model may consider multiple attributes of both the opportunity and the applicant, such as the job title associated with each, the industry associated with each, the seniority level of each, the years of experience of each, the skills of each, and number (and, optionally, quality) of endorsements of the applicant. For example, the more skills that match between the applicant and the opportunity, the higher the match score. As another example, if the number of years of experience of an applicant is within a year range of experience indicated in the opportunity (e.g., its job posting), then the match score will be higher, all else being equal.

### Minimum Threshold

In an embodiment, a minimum threshold match score is used as a first pass filter to filter applicants for an opportunity. Thus, if a match score of an applicant to an opportunity (to which the applicant applied) is before the minimum threshold, then no assessment invitation is sent to the applicant. Instead, reviewer database 136 may be updated to indicate that the applicant did not meet the minimum threshold and is no longer being considered. Alternatively, an entry that associates the applicant with the opportunity may be removed or made invisible so that a reviewer of the opportunity will not see data about the applicant. Additionally, server system 130 may automatically notify the applicant that s/he is not being considered for the opportunity. Additionally, an entry in seeker database 138 for the applicant may be updated (e.g., by seeker portal 140 or another component of server system 130) to indicate that the applicant is not longer considered for the opportunity. In this way, the applicant may view all the opportunities (for which the applicant has applied) and see which ones are still pending or which ones have not made a final decision.

### Triggering an Assessment Invitation

As noted herein, assessment selector 142 takes into account one or more factors in making a determination regarding whether to send an assessment invitation to an applicant. Assessment selector 142 may be triggered for each applicant on each active opportunity indicated in opportunity database 132. There may be hundreds or thousands of opportunities and hundreds of applicants for each opportunity.

Example factors include a likelihood that a reviewer of the corresponding opportunity will review results of the assessment in the next time window T, a likelihood that the applicant, when invited to take the assessment, will complete the assessment within the time window T, and a likelihood that the applicant is one of the top N candidates that the reviewer should review in the next review session.

### Triggering an Assessment Invitation: Time Window

Regarding the likelihood that a reviewer of applicants of an opportunity will review results of an assessment taken by an applicant within the next time window T, such a likelihood may be determined based on one or more other factors (or sub-factors), such as how frequently the reviewer reviews candidates (e.g., every day, every six days, every month), a number of applicants the reviewer has reviewed in prior review sessions (e.g., a median or average, such as 6.5 per review session), a number of “pending assessment invitations” for the reviewer (or assessment invitations that have been sent to applicants but not yet completed), and a number of completed assessments that have not yet been reviewed by the reviewer. The first two types of data constitute a “review history” of the reviewer. The larger the number of reviews per session, the more assessment invitations will be sent. The review history may be derived from reviewer database 136. The last two types of data are considered a “current workload” of the reviewer. The higher the current workload of a reviewer, the less likely that the reviewer will review all the assessments. Also, if the number of completed but not yet reviewed assessments is greater than the average number of applicants reviewed in prior review sessions, then the less likely assessment selector 142 will send an assessment invitation to the current applicant.

Some reviewers may have little to no review history. In that case, a review history of another reviewer (or group of reviewers) that is similar to the reviewer may be leveraged. Examples of the other reviewer or group of reviewers include someone from the same company as the reviewer, someone in the same industry as the reviewer, and someone who looking at candidates for one or more opportunities pertaining to an industry that matches the industry of the corresponding opportunity. As a reviewer obtains more and more review history, the weight given to that review history will increase relative to the weight given to the review history of another reviewer or a group of reviewers.

### Triggering an Assessment Invitation: Completion

Regarding the likelihood that an applicant, when invited to take an assessment, will complete the assessment within time window T, such a likelihood may be determined based on one or more sub-factors, such as the data stored in, or derived based on, seeker database 138 and, optionally, reviewer database 136. Examples of such data include a number of opportunities that the applicant has applied for in a certain period of time (e.g., the last week), a number of opportunities that the applicant might apply for in a given time period, a number of assessment invitations that the applicant has received but not taken the assessment, a number of assessments that the applicant has complete, a ratio of the number of assessments completed and the number of assessments invitations received, an average or median time between receiving an assessment invitation and completing the assessment, a percentage of assessments that the applicant has successfully passed, and, at any point in time, a number of opportunities for which the applicant is being considered by one or more reviewers.

Such data may be generated by seeker portal 140, assessment selector 142, or another component (not depicted) of server system 130.

Assessment selector 142 may also determine, for a given opportunity for which an applicant has applied, how engaged the applicant will be for this opportunity in light of the applicant's progress and likelihood of becoming a hire for all other opportunities with which the applicant has interacted (e.g., applied, assessment accepted, assessment begun, assessment completed, interviewed). Assessment selector 142 may also determine or calculate an expected time delay of an applicant responding to a new assessment invitation/request and/or a probability of the applicant getting a passing (or failing) grade from the assessment, if completed. The expected time delay may be based on the applicant's “current workload.” Examples of an applicant's current workload include the number of pending assessments to take, the number of writing assignments (e.g., cover letters), the number of interviews to schedule, and the number of interviews to attend. Generally, the greater an applicant's workload, the less likely that the applicant will respond to an assessment request, unless the applicant is very active and, optionally, has no current prospects (e.g., interviews scheduled).

The above class of data helps determine the chances of an applicant responding to an assessment request and the expected time delay of completing the assessment. Based on these parameters, some candidates may have very different response patterns than others and, therefore, in an embodiment, assessment invitations are triggered to different candidates at different times with the intention of having the assessment results from the right candidate available to the reviewer for review at the right date.

For example, if assessment selector 142 determines that an applicant is very likely to complete an assessment (e.g., given the applicant's history of completing assessments), but that the applicant is not expected to take the assessment for another two weeks (e.g., given the applicant's current workload), then assessment selector 142 may determine to place the applicant (or data indicating the applicant) in a queue for later consideration, as described in more detail herein. As another example, assessment selector 142 determines that, although the applicant has a low current assessment workload and the applicant is likely to complete the assessment, because the applicant has recently participated in multiple on-site interviews for other opportunities, no assessment invitation will be sent to the applicant.

In some cases, an applicant might have little or no assessment history. In such cases, the assessment history of one or more similar applicants (e.g., in job title, industry, geography, and/or seniority) may be combined and the combined assessment history may be used as the assessment history for the applicant until more assessment history about the applicant is accumulated.

### Triggering an Assessment Invitation: Top Candidate

Regarding the likelihood that an applicant is one of the top N candidates that a reviewer should review in the next review session, such a likelihood may be determined based on one or more sub-factors, such as profile metadata (or features) of the applicant and features that are relevant to the reviewer. An example of such a sub-factor is the match score described herein. Another example is leveraging a model that is trained based on previous match scores of other applicants of other opportunities and, for each applicant, whether the applicant completed an assessment (one label), whether the applicant was invited to an interview (another label), whether the applicant had an onsite interview (another label), whether the applicant received an offer (another label), and whether the applicant accepted the offer (another label). The output of the trained model may be input to assessment selector 142 in determining a likelihood that the applicant is one of the top N candidates that a reviewer should review.

In a related embodiment, assessment selector 142 ranks a set of applicants that have taken an assessment (e.g., in response to an assessment invitation). The ranking may be based on one or more factors, such as score on the assessment, a match score between the opportunity and the applicant, and a likelihood that the applicant will be hired, which may be taken into account the match score or be independent thereof. The ranking allows a reviewer to review applicants in the order of the ranking. If N candidates have already been identified for a reviewer, the reviewer has not yet reviewed the N candidates, and assessment selector 142 determines (or predicts) that the latest applicant (for which an assessment invitation has not yet been sent) is likely to be in the top N candidates, then assessment selector 142 may determine to send an assessment invitation to that applicant, even though N candidates have already taken the assessment and are deemed to be a sufficient number for the reviewer to consider in the next review session.

### Queue of Reconsideration

In an embodiment, assessment selector 142 determines to place an applicant in a queue for reconsideration. For example, assessment selector 142 determines that, while the applicant is highly qualified and likely to accept an offer from the job provider, the reviewer is likely to not review assessments for another week and the applicant is likely to take the assessment immediately. Therefore, if an assessment invitation is sent immediately, then the applicant is likely to wait for a week before hearing back from the reviewer. In order to reduce that delay, assessment selector 142 places the applicant (or, rather, data that represents the applicant) in a queue for later processing. In a related embodiment, assessment selector 142 places time data that indicates when the applicant should be reconsidered and/or when to send the assessment invitation. If the latter, then assessment selector 142 is not required to consider the one or more factors again and, thus, save on processing time. If the former, then assessment selector 142 may have new information that influence whether the assessment invitation should be sent immediately, later, or not at all. For example, after being placed in the queue, the applicant may have accepted another opportunity and, therefore, is no longer a candidate for the opportunity in question.

In a related embodiment, assessment selector 142 inserts, into the queue, a second applicant for a certain opportunity at a position that is before the position of a first applicant (for the same opportunity) that assessment selector 142 inserted into the queue. Such a decision may be made because assessment selector 142 determines that the second applicant (though applied after the first applicant) is a better fit for the opportunity or is more likely to complete (and/or pass) the assessment in the time window T.

### Additional Examples

A reviewer has a history of review sessions that are roughly 20 days apart of each other. For each review session, the reviewer typically reviews between 10-15 applicants. A particular applicant applied for an opportunity that the reviewer is assigned to review. The reviewer conducted a review session 8 days ago and there are nine other applicants in the queue for the opportunity. The particular applicant typically takes two weeks to take an assessment. Based on this information, assessment selector 142 determines to send an assessment invitation to the particular applicant immediately even though the particular applicant's response rate is relatively low (e.g., 20%, meaning the applicant takes 20% of the assessments to which the applicant is invited to take). The nine other applicants might not have been sent an assessment invitation because they have a history of taking assessments within one day of receiving the corresponding invitations. Thus, to avoid a likely delay between completing an assessment and hearing back from the reviewer, assessment selector 142 determined to place those nine applicants in the queue.

In another example, a reviewer has a history of conducting daily review sessions. In the last five review sessions, the reviewer has steadily decreased the number of applicants that s/he reviewed from 10 to 5. There are currently 20 pending assessment invitations and no completed assessments. However, given the probability of each of the 20 applicants completing the assessment within 24 hours, only 2 of the 20 are predicted to complete the assessment within 24 hours. A particular applicant applied for an opportunity that the reviewer is assigned to review. The particular applicant typically takes an assessment immediately. Based on this information, assessment selector 142 determines to send an assessment invitation to the particular applicant immediately since 5 (what the reviewer is likely to review in the next day) is greater than 2 (which is the number of predicted completions available for review).

Generally, assessment selector 142 may send out (a) relatively many invitations (e.g., one hundred) if the expected number of completions is relatively low and/or the reviewer has a relatively high review rate and (b) relatively few invitations (e.g., ten) if the expected number of completions is relatively high and/or the reviewer has a relatively low review rate. Rules may

### Applicant Reranking

In an embodiment, server system 130 re-ranks applicants that have completed an assessment for an opportunity and/or applicants that have not completed the assessment for the opportunity. Initially, given a new opportunity (or job posting), a machine-learned (ML) ranking model ranks applicants by relevance to the new opportunity. The ML ranking model may be trained based on information pertaining to multiple opportunities from different job providers.

As a reviewer performs actions relative to different applicants, these actions constitute labels that are used to re-train the ranking model for reranking applications, such as applicants that have completed the assessment and/or applicants that have been assigned to the reconsideration queue. Thus, a different version of the ranking model may exist for different reviewers. Example actions that a reviewer might perform relative to an applicant include an assessment invitation, marking the applicant as a good fit, marking the applicant as a bad fit, sending a message to the applicant, downloading the applicant's resume, and inviting the applicant to participate in an interview. For each applicant that is associated with a label, a training instance is generated. A set of such training instances is used to re-train the ranking model. Some of the training instances (i.e., pertaining to other reviewers or other opportunities) that were used to train the previous version of the ranking model may be removed, such that those training instances do not influence the weights learned for the current features of the ranking model. The re-trained ranking model is then used to score applicants that have completed the corresponding assessment and/or applicants that have not yet received an assessment invitation.

In an embodiment, assessment result/score is a feature in the ML ranking model. Assessment results are not available, by definition, in the initial applicant rankings. Instead, the assessment results only materialize when applicants complete assessments and as reviewers review the results. As a result, a ranking of applicants may be re-calculated with each assessment result. The assessment results are associated with weights to influence reviewer actions relative to applicants.

The possible range of feature values may be from 0 to 100 or may be a limited set of values, such as pass or fail, or high pass, low pass, and fail. Therefore, after an applicant takes an assessment, the score is one of the inputs to the ranking model to re-rank that applicant relative to other applicants that have taken the assessment.

In a related embodiment, for applicants that have applied for an opportunity but have not yet received an assessment invitation (e.g., applicants assigned to the waiting queue), the ranking model may be used to rank the applicants even though no assessment score is available for those applicants. For example, a passing score may be a default score for all such applicants. As another example, assessment selector 142 determines a predicted assessment score for each applicant and uses that predicted score as input to the model to rank such applicants. In some situations, an initially lower ranked applicant in the query may, after a re-ranking, have a higher ranking.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

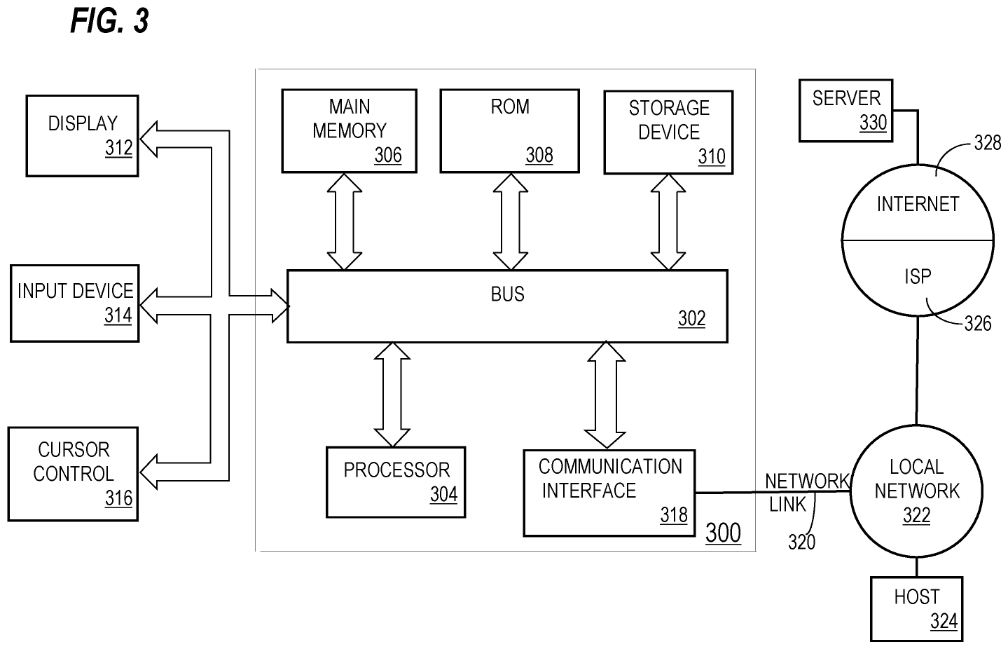

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing one or more assessments for applicants of an opportunity;
receiving first input that indicates that a first user applied for the opportunity;
in response to receiving the first input, automatically determining whether to transmit a first assessment invitation to the first user;
automatically determining to transmit the first assessment invitation to a computing device of the first user;
receiving second input that indicates that a second user applied for the opportunity;
in response to receiving the second input, automatically determining whether to transmit a second assessment invitation to the second user;
automatically determining to not transmit the second assessment invitation to the second user;
wherein the method is performed by one or more computing devices.

2. The method of claim 1, further comprising:
assigning the second user to a queue of applicants that have not received an assessment invitation for the opportunity;
after assigning the second user to the queue of applicants and after automatically determining to not transmit the second assessment invitation to the second user, automatically determining whether to transmit the second assessment invitation to the second user;
automatically determining to transmit the second assessment invitation to the second user.

3. The method of claim 1, wherein automatically determining to transmit the first assessment invitation to the first user comprises automatically determining to delay transmitting the first assessment invitation to the first user for a period of time, the method further comprising:
in response to determining that the period of time has lapsed, transmitting the first assessment invitation to the first user.

4. The method of claim 1, further comprising:
prior to receiving the first input, storing review data that indicates one or more attributes associated with an entity that reviews applicants to the opportunity;
wherein automatically determining whether to transmit the first assessment invitation to the first user is based on the review data.

5. The method of claim 4, wherein the one or more attributes associated with the entity comprises a history of reviewing one or more assessments taken by a set of applicants to one or more opportunities.

6. The method of claim 5, wherein the one or more opportunities do not include the opportunity.

7. The method of claim 4, wherein the one or more attributes associated with the entity comprises a number of current applicants to the opportunity for the entity to review.

8. The method of claim 1, further comprising:
prior to receiving the first input, storing seeker data that indicates one or more attributes associated with the first user;
wherein automatically determining whether to transmit the first assessment invitation to the first user is based on the seeker data.

9. The method of claim 8, wherein the one or more attributes associated with the first user are based on one or more of:
a number of invitations that the first user has received to take an assessment,
a number of assessments that the first user has completed, or
a number of previous assessments that the first user has passed.

10. The method of claim 8, wherein the one or more attributes associated with the first user are based on one or more of:
a number of uncompleted assessments assigned to the first user,
a number of uncompleted writing assignments associated with the first user,
a number of interviews for the first user to schedule, or
a number of scheduled interviews for the first user to attend.

11. The method of claim 1, further comprising:
determining, based on one or more attributes associated with an entity that reviews applicants to the opportunity, an amount of time to complete the one or more assessments;
transmitting, to the first user, the first assessment invitation and time data that indicates the amount of time to complete the one or more assessments.

12. A method comprising:
storing an assessment for applicants of an opportunity;
storing reviewer history data that is based on a number of previous assessments that an entity that reviews applicants to the opportunity reviewed;
receiving input that indicates that a particular user applied for the opportunity; in response to receiving the input:
determining one or more attributes, of the particular user, that pertain to assessments;
based on the reviewer history data and the one or more attributes, automatically determining whether to transmit an assessment invitation to a computing device of the particular user;
wherein the method is performed by one or more computing devices.

13. One or more storage media storing instructions which, when executed by one or more processors, cause:
storing one or more assessments for applicants of an opportunity;
receiving first input that indicates that a first user applied for the opportunity;
in response to receiving the first input, automatically determining whether to transmit a first assessment invitation to the first user;
automatically determining to transmit the first assessment invitation to a computing device of the first user;
receiving second input that indicates that a second user applied for the opportunity;
in response to receiving the second input, automatically determining whether to transmit a second assessment invitation to the second user;
automatically determining to not transmit the second assessment invitation to the second user.

14. The system of claim 13, wherein the instructions, when executed by the one or more processors, further cause:
assigning the second user to a queue of applicants that have not received an assessment invitation for the opportunity;
after assigning the second user to the queue of applicants and after automatically determining to not transmit the second assessment invitation to the second user, automatically determining whether to transmit the second assessment invitation to the second user;
automatically determining to transmit the second assessment invitation to the second user.

15. The system of claim 13, wherein automatically determining to transmit the first assessment invitation to the first user comprises automatically determining to delay transmitting the first assessment invitation to the first user for a period of time, wherein the instructions, when executed by the one or more processors, further cause:
in response to determining that the period of time has lapsed, transmitting the first assessment invitation to the first user.

16. The system of claim 13, wherein the instructions, when executed by the one or more processors, further cause:
prior to receiving the first input, storing review data that indicates one or more attributes associated with an entity that reviews applicants to the opportunity;
wherein automatically determining whether to transmit the first assessment invitation to the first user is based on the review data.

17. The system of claim 16, wherein the one or more attributes associated with the entity comprises (a) a history of reviewing one or more assessments taken by a set of applicants to one or more opportunities or (b) a number of current applicants to the opportunity for the entity to review.

18. The system of claim 13, wherein the instructions, when executed by the one or more processors, further cause:
prior to receiving the first input, storing seeker data that indicates one or more attributes associated with the first user;
wherein automatically determining whether to transmit the first assessment invitation to the first user is based on the seeker data.

19. The system of claim 18, wherein the one or more attributes associated with the first user are based on one or more of:
a number of invitations that the first user has received to take an assessment,
a number of assessments that the first user has completed,
a number of previous assessments that the first user has passed,
a number of uncompleted assessments assigned to the first user,
a number of uncompleted writing assignments associated with the first user,
a number of interviews for the first user to schedule, or
a number of scheduled interviews for the first user to attend.

20. The system of claim 13, wherein the instructions, when executed by the one or more processors, further cause:
determining, based on one or more attributes associated with an entity that reviews applicants to the opportunity, an amount of time to complete the one or more assessments;
transmitting, to the first user, the first assessment invitation and time data that indicates the amount of time to complete the one or more assessments.
